(19) United States
(12) Patent Application Publication
(10) Pub. No.: US 2017/0072640 A1
(43) Pub. Date: Mar. 16, 2017

(54) 3D Printing Portal for Crowd-Sourced Designs

(71) Applicant: Caterpillar Inc., Peoria, IL (US)

(72) Inventor: Tazio S. Grivetti, Chillicothe, IL (US)

(73) Assignee: Caterpillar Inc., Peoria, IL (US)

(21) Appl. No.: 14/851,262

(22) Filed: Sep. 11, 2015

(51) Int. Cl. B29C 67/00; G05B 19/4099; G06K 9/00

(52) U.S. Cl. CPC B29C 67/0088; G06K 9/00476; G06K 9/00456; G05B 19/4099; G05B 2219/35134; G05B 2219/49007; B33Y 50/02

(57) ABSTRACT

A method includes receiving a design file in a first format at a computer-based system, wherein the design file is indicative of a structural design. The method includes categorizing the structural design into a first category based on at least a structure type associated with the structural design. The method includes analyzing the structural design, by the computer-based system, based on at least a structural criterion and assigning a structural value to the structural design based on at least the analyzing of the structural design. The method includes generating an additive manufacturing design based on at least the structural design, wherein the additive manufacturing design is generated in a second format and is configured to be processed by an additive manufacturing machine to construct at least a portion of a structure based on at least the structural design in a layer-by-layer manner. The method includes causing a display to be rendered, the display comprising a three-dimensional representation of the structural design, the first category, and the first structural value, wherein the structural type is at least one of a building type or a component type.

### TECHNICAL FIELD

The present disclosure generally relates to a computer-based system. More particularly, the present disclosure relates to the computer-based system providing assistance to designers and customers for three-dimensional constructions.

### BACKGROUND

Recently, technologies related to constructing structures such as, buildings, houses, and the like using additive manufacturing machines, also referred to as three-dimensional (3D) printing machines, have been developed. Typically, in such cases, a design of the structure may be provided to the 3D printing machine, which may deposit and extrude a material to build the structure according to the design. Moreover, the design may include layer by layer sliced format. Such designs may be developed by designers, structural engineers and the like. However, it may be difficult for these designers to get their work in front of a broad audience for review and possible purchase by customers. Further, the customers may be able to view only a simple model or pictures of the purchased designs.

For reference, U.S. Pat. No. 8,161,411 is related to improved graphical user interfaces (hereinafter the GUI's of the '411 patent) suitable for reviewing, browsing, previewing and/or purchasing media items. The graphical user interfaces are suitable for reviewing or browsing numerous media items. The graphical user interfaces are also suitable for previewing or purchasing media items in an on-line manner. The graphical user interfaces are particularly useful for a system that provides purchase and distribution of media in a client-server environment.

However, the GUI's of the '411 patent may not provide an analysis of each of the media items so as to facilitate a user to make a decision on the purchase of a particular media item. Further, the GUI's of the '411 patent does not allow integrating and/or viewing different combinations of the media items i.e., the designs into a single structure.

### SUMMARY

In one aspect, this disclosure is directed to a method. The method may include receiving a design file in a first format at a computer-based system, wherein the design file is indicative of a structural design. The method may include categorizing the structural design into a first category based on at least a structure type associated with the structural design. The method may include analyzing the structural design, by the computer-based system, based on at least a structural criterion and assigning a structural value to the structural design based on at least the analyzing of the structural design. The method may include generating an additive manufacturing design based on at least the structural design, wherein the additive manufacturing design is generated in a second format and is configured to be processed by an additive manufacturing machine to construct at least a portion of a structure based on at least the structural design in a layer-by-layer manner. The method may include causing a display to be rendered, the display comprising a three-dimensional representation of the structural design, the first category, and the first structural value, wherein the structural type is at least one of a building type or a component type.

In another aspect, this disclosure is directed to a method. The method may include receiving a first format of a structural design at a computer-based system and sorting the structural design, by the computer-based system, into a category based on at least a type of physical structure associated with the structural design. The method may include analyzing the structural design based on at least a structural criterion and assigning a first structural value to the structural design based on at least the analyzing of the structural design. The method may include generating an additive manufacturing design based on at least the structural design, wherein the additive manufacturing design is generated in a second format and is configured to be processed by an additive manufacturing machine to construct at least a portion of a structure.

In yet another aspect, this disclosure is directed to a system comprising a user interface. The system may include a design tool for receiving a structural design in a first format from a first user via the user interface, the structural design having a structure type. The system may include an analytics engine configured to determine a first category of the structural design based on at least the structure type and analyze the structural design based on at least a structural criterion. The analytics engine may be configured to assign a structural value to the structural design based on at least the analyzing of the structural design. The analytics engine may be configured to generate an additive manufacturing design based on at least the structural design. The additive manufacturing design may generated in a second format and may be configured to be processed by an additive manufacturing machine to construct at least a portion of a structure.

Other features and aspects of this disclosure will be apparent from the following description and the accompanying drawings.

### BRIEF DESCRIPTION OF THE DRAWINGS

FIG. 1 is a block diagram of an exemplary environment in which a three-dimensional (3D) construction assistance module may be deployed, according to an aspect of the present disclosure.

FIG. 2 is a block diagram illustrating an exemplary implementation of the 3D construction assistance module, according to an aspect of the present disclosure.

FIG. 3 is an exemplary output displayed on an exemplary graphical user interface (GUI) associated with the 3D construction assistance module of FIG. 2, according to an aspect of the present disclosure.

FIG. 4 is an exemplary data flow associated with the 3D construction assistance module of FIG. 2, according to an aspect of the present disclosure.

FIG. 5 is a block diagram of an exemplary computer system, according to an aspect of the present disclosure.

FIG. 6 illustrates a flowchart for a method of implementing an interface that enables users to select one or more designs to be used in 3D construction of a physical structure, according to an aspect of the present disclosure.

FIG. 7 illustrates a flowchart for a method of implementing an interface that enables users to select one or more designs to be used in 3D construction of a physical structure, according to an aspect of the present disclosure.

### DETAILED DESCRIPTION

Additive manufacturing or “3D printing” can be used to form various components from small plastic toys to vehicle parts, medical devices, and even building structures such as homes and protective structures. Currently, designs to be printed using the 3D printer apparatus are prepared and printed as a service to the end user. Customization of components may require the direct commissioning of a designer and printer to provide the custom components.

The present disclosure relates to a universal platform and design tool for designers to prepare and upload any number of 3D design components to a network portal. As an example, the design tool can be hosted in the cloud to allow all designers to have access to the same tool for designing. Customers can access the network portal to review and purchase any number of the designs in the uploaded catalogue of designs.

Designers can view, change, and add to designs of others and can create components of a whole structure or the whole structure itself. Submitted designs can be analyzed via structural algorithms, committee review, expert validation, and the like to provide a threshold quality control and optionally a structural ranking Such ranking can be based on at least a tiered scale for various environmental conditions and may reflect other metrics such as cost, aesthetics, material grade, and the like. The submitted designs can be processed to format the design for 3D printing. Ancillary components such as a windows and doors can be incorporated into the design for visualization and potential ancillary purchase opportunity. Designs can be tagged with metadata for sorting and/or processing.

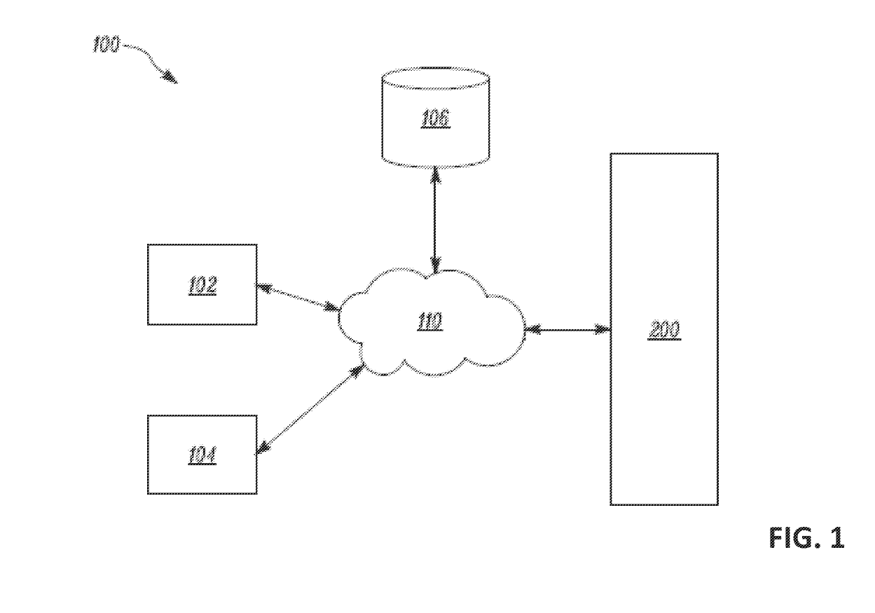

Now referring to the drawings, wherein like reference numbers refer to like elements, there is illustrated an example environment 100 in which the present disclosure may be utilized, in accordance with an aspect of the disclosure. As shown in FIG. 1, for example, the environment 100 includes a first user 102, a second user 104, a database 106, and a communication network 110. The first user 102, the second user 104, and the database 106 may communicate with each other over the communication network 110. Examples of the communication network 110 may include, but are not limited to, a wide area network (WAN), a local area network (LAN), an Ethernet, Internet, an Intranet, a cellular network, a satellite network, or any other suitable network for transmitting data. The communication network 110 may be implemented as a wired network, a wireless network, or a combination thereof.

The first user 102 and the second user 104 may comprise any hardware and/or software suitably configured to facilitate input, receipt and/or review of information relating to a 3D construction assistance program or any information discussed herein. The database 106 may include any device (e.g., personal computer) that communicates (in any manner discussed herein) with the first user 102 and the second user 104 via any network discussed herein. These computing units or systems may take the form of a computer or set of computers, although other types of computing units or systems may be used, including laptops, notebooks, handheld computers, mobile devices, set-top boxes, workstations, computer-servers, main frame computers, mini-computers, PC servers, pervasive computers, network sets of computers, or the like. Practitioners will appreciate that the database 106 may or may not be in direct contact with the first and second users 102, 104. For example, the first user 102 or the second user 104 may access the services of the database 106 through a remote server, which may have a direct or indirect connection to the communication network 110.

As those skilled in the art will appreciate, the first user 102 and the second user 104 may include an operating system (e.g., Windows NT, 95/98/2000, OS2, UNIX, Linux, Solaris, MacOS, etc.), as well as various conventional support software and drivers typically associated with computers. Further, the first user 102 and the second user 104 may include any suitable personal computer, network computer, workstation, minicomputer, mainframe, tablet, mobile devices or the like. Furthermore, the first user 102 and the second user 104 may be in a home, business environment, or public places with access to a network, for example, airports. In an example aspect, access is through a network or the Internet through a commercially available web-browser software package.

In an example implementation as shown in FIG. 1, a 3D construction assistance module 200 (hereinafter referred to as “the assistance module 200”) may be communicatively coupled to the first user 102 via the communication network 110. In an aspect, the assistance module 200 may be deployed on one or more servers associated with the first user 102 or the second user 104. In another aspect, the assistance module 200 may be deployed as a separate entity on a third party server.

The database 106 may be configured to store design information, such as initial concept design files, work in progress design files, completed design files, approved design files that may have passed the strength criteria for each of the first users 102. The design information may also include files of working components, completed components associated with each of the first user 102. The database 106 may also be configured to store various hardware files related to each of the design files for example, designs of ancillary components associated with the designs. In an example, the ancillary components may include a doorway or window lintel, hinges, fasteners and the like that may be designed to be partially or completely encompassed by the extruded material during the 3D construction.

Further, the database 106 may also include data related to user profiles for each of the first user 102 and the second user 104. For example, the user profile may include a name, an address, and contact details such as e-mail address, phone number, correspondence address, social security number, and the like. Further, the database 106 may also be configured to store transaction history of the users, account receivable information, credit bureau information, transaction account data associated with the second users 104, one or more preference settings of the users, and data from any third-party sources. For example, the database 106 may also store account history of the second user 104, such as designs viewed by the second user 104, designs saved/archived for later review, designs purchased by the second user 104, and the like. In various aspects, the assistance module 200 may be in communication with various third-party sources to retrieve the relevant information.

The database 106 may employ any type of database, such as relational, hierarchical, graphical, object-oriented, or other database configurations. Common database products that may be used to implement the database 106 include DB2 by IBM (White Plains, N.Y.), various database products available from Oracle Corporation (Redwood Shores, Calif.), Microsoft Access or Microsoft SQL Server by Microsoft Corporation (Redmond, Wash.), or any other suitable database product. Moreover, the databases 106 may be organized in any suitable manner, for example, as data tables or lookup tables. Each record may be a single file, a series of files, a linked series of data fields, or any other data structure. Association of certain data may be accomplished through any desired data association technique, such as those known or practiced in the art. For example, the association may be accomplished either manually or automatically. Automatic association techniques may include, for example, a database search, a database merge, GREP, AGREP, SQL, using a key field in the tables to speed searches, sequential searches through all the tables and files, sorting records in the file according to a known order to simplify lookup, or the like. The association step may be accomplished by a database merge function, for example, using a “primary key field” (hereinafter “key field”), in pre-selected databases or data sectors.

More particularly, a key field may partition the database according to the high-level class of objects defined by the key field. For example, certain types of data may be designated as a key field in a plurality of related data tables, and the data tables may then be linked on the basis of the type of data in the key field. The data corresponding to the key field in each of the linked data tables is preferably the same or of the same type. However, data tables having similar, though not identical, data in the key fields may also be linked by using AGREP, for example. In accordance with one aspect of the disclosure, any suitable data storage technique may be utilized to store data without a standard format. Data sets may be stored using any suitable technique, including, for example, storing individual files using an ISO/DEC 7816-4 file structure; implementing a domain whereby a dedicated file is selected that exposes one or more elementary files containing one or more data sets; using data sets stored in individual files using a hierarchical filing system; data sets stored as records in a single file (including compression, SQL accessible, hashed via one or more keys, numeric, alphabetical by first tuple, etc.); Binary Large Object (BLOB); stored as ungrouped data elements encoded using ISO/IEC 7816-6 data elements; stored as ungrouped data elements encoded using ISO/IEC Abstract Syntax Notation (ASN.1) as in ISO/IEC 8824 and 8825; or other proprietary techniques, which may include fractal compression methods, image compression methods, etc.

In one example aspect, the ability to store a wide variety of information in different formats is facilitated by storing the information as a BLOB. Thus, any binary information can be stored in a storage space associated with a data set. As discussed above, the binary information may be stored on the financial transaction instrument or external to but affiliated with the financial transaction instrument. The BLOB method may store data sets as ungrouped data elements formatted as a block of binary via a fixed memory offset using one of fixed storage allocation, circular queue techniques, or best practices with respect to memory management (e.g., paged memory, least recently used, etc.). By using BLOB methods, the ability to store various data sets that have different formats facilitates the storage of data associated with the system by multiple and unrelated owners of the data sets. For example, a first data set, which may be stored, may be provided by a first party, a second data set, which may be stored, may be provided by an unrelated second party, and yet a third data set, which may be stored, may be provided by a third party unrelated to the first and second party. Each of these three example data sets may contain different information that is stored using different data storage formats or techniques. Further, each data set may contain subsets of data that also may be distinct from other subsets.

As stated above, in various aspects of the database 106, the data can be stored without regard to a common format. However, in one example aspect of the disclosure, the data set (e.g., BLOB) may be annotated in a standard manner when provided for manipulating the data onto the financial transaction instrument. The annotation may comprise a short header, trailer, or other appropriate indicator related to each data set that is configured to convey information useful in managing the various data sets. For example, the annotation may be called a “condition header,” “header,” “trailer,” or “status,” herein, and may comprise an indication of the status of the data set or may include an identifier correlated to a specific issuer or owner of the data. In one example, the first three bytes of each data set BLOB may be configured or configurable to indicate the status of that particular data set: e.g., LOADED, INITIALIZED, READY, BLOCKED, REMOVABLE, or DELETED. Subsequent bytes of data may be used to indicate for example, the identity of the issuer, user, transaction/membership account identifier or the like. Each of these condition annotations are further discussed herein.

The data set annotation may also be used for other types of status information as well as various other purposes. For example, the data set annotation may include security information establishing access levels. The access levels may, for example, be configured to permit only certain individuals, levels of employees, companies, or other entities to access data sets, or to permit access to specific data sets based on at least the transaction, the first user 102, the second user 104 or the like. Furthermore, the security information may restrict/permit only certain actions such as accessing, modifying, or deleting data sets. In one example, the data set annotation indicates that only the data set owner or the user are permitted to delete a data set, various identified users may be permitted to access the data set for reading, and others are altogether excluded from accessing the data set. However, other access restriction parameters may also be used allowing various entities to access a data set with various permission levels as appropriate. The data, including the header or trailer may be received by a standalone interaction device configured to add, delete, modify, or augment the data in accordance with the header or trailer. As such, in one aspect, the header or trailer is not stored on the transaction device along with the associated issuer-owned data, but instead the appropriate action may be taken by providing, to the transaction instrument user at the standalone device, the appropriate option for the action to be taken. The database 106 contemplates a data storage arrangement wherein the header or trailer, or header or trailer history, of the data is stored on the transaction instrument in relation to the appropriate data. One skilled in the art will also appreciate that, for security reasons, any databases, systems, devices, servers or other components of the database 106 may consist of any combination thereof at a single location or at multiple locations, wherein each database or system includes any of various suitable security features, such as firewalls, access codes, encryption, decryption, compression, decompression, or the like.

The disclosure may be described herein in terms of functional block components, screenshots, optional selections and various processing steps. It should be appreciated that such functional blocks may be realized by any number of hardware or software components configured to perform the specified functions. For example, the assistance module 200 may employ various integrated circuit components, e.g., memory elements, processing elements, logic elements, look-up tables, or the like, which may carry out a variety of functions under the control of one or more microprocessors or other control devices. Similarly, the software elements of the assistance module 200 may be implemented with any programming or scripting language such as C, C++, Java, COBOL, assembler, PERL, Visual Basic, SQL Stored Procedures, extensible markup language (XML), with the various algorithms being implemented with any combination of data structures, objects, processes, routines, or other programming elements. Further, it should be noted that the assistance module 200 may employ any number of conventional techniques for data transmission, signaling, data processing, network control, or the like. Still further, the assistance module 200 could be used to detect or prevent security issues with a client-side scripting language, such as JavaScript, VBScript, or the like.

These software elements may be loaded onto a general-purpose computer, special purpose computer, or other programmable data-processing apparatus to produce a machine, such that the instructions that execute on the computer or other programmable data-processing apparatus create means for implementing the functions specified in the flowchart block or blocks. These computer program instructions may also be stored in a computer-readable memory that can direct a computer or other programmable data-processing apparatus to function in a particular manner, such that the instructions stored in the computer-readable memory produce an article of manufacture including instruction means which implement the function specified in the flowchart block or blocks. The computer program instructions may also be loaded onto a computer or other programmable data-processing apparatus to cause a series of operational steps to be performed on the computer or other programmable apparatus to produce a computer-implemented process such that the instructions which execute on the computer or other programmable apparatus provide steps for implementing the functions specified in the flowchart block or blocks.

In an aspect, the computer program instructions may be executed on any remote hosted application framework, for example, by a processor associated with a cloud server. Accordingly, the first user 102 or the second user 104 may access the cloud server via any interfaces connected to the internet.

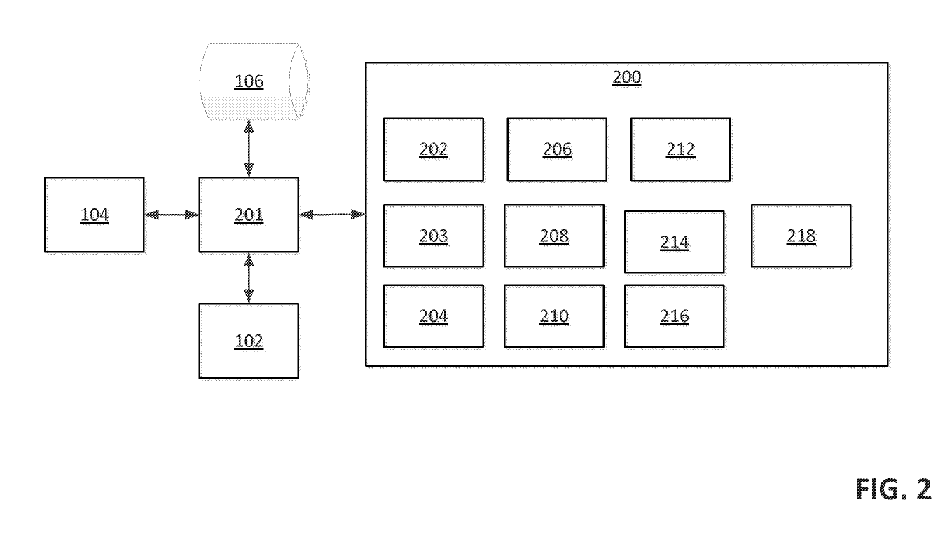

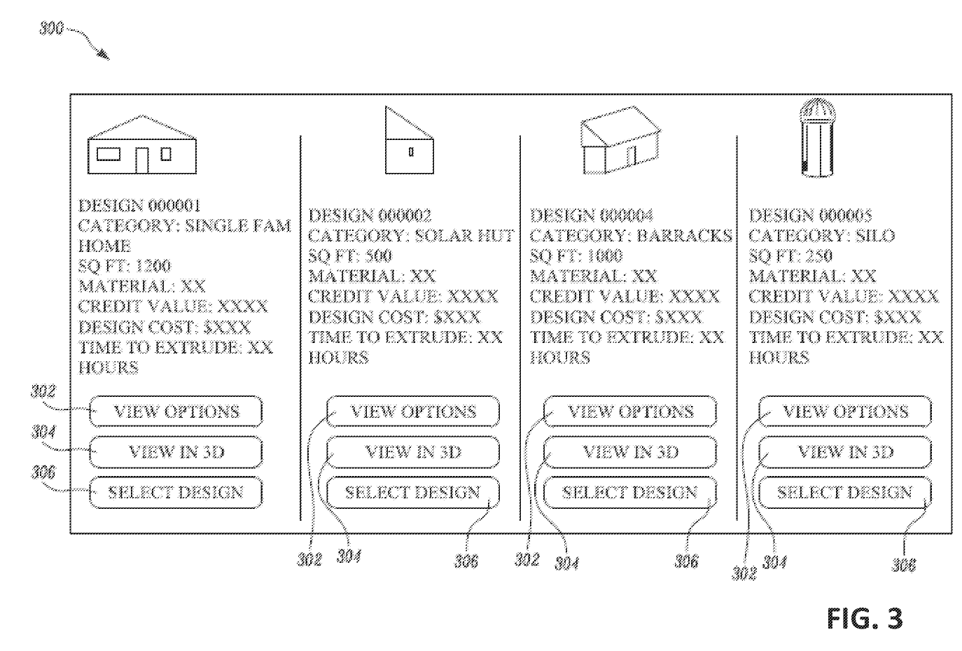

Referring to FIG. 2, an example implementation of the assistance module 200 is depicted, according to an aspect of the present disclosure. In the illustrated aspect, the assistance module 200 includes a design module 202, a user interface 203, a sorting module 204, an analytics engine 206, a display module 208, a selecting module 210, a building module 212, a transform module 214, a download module 216, and a payment module 218 as shown. In an aspect, one or more of the design module 202, the user interface 203, the sorting module 204, the analytics engine 206, the display module 208, the selecting module 210, the building module 212, the transform module 214, the download module 216, or the payment module 218 may include software instructions stored on memory to be run on a processor. The assistance module 200 may be associated with a graphical user interface (GUI), such as GUI 300 shown in FIG. 3.) The assistance module 200 may be communicatively coupled to a server 201. For example, a portion or the entire assistance module 200 may be stored in memory of the server 201 or in memory communicatively coupled to the server 201. In an example, the server 201 may be a web-based server. Further, the assistance module 200 may be configured to communicate with the database 106 and other third-party sources through the communication network 110, as illustrated in FIG. 1.

As will be understood, the modules of the assistance module 200 discussed above may be arranged in any combination. For example, the user interface 203 may be integrated into design module 202. Likewise, the user interface 203 may be incorporated into the display module 208. The modules of the assistance module 200 may include hardware and or software.

In an aspect, the design module 202 may be configured to receive one or more designs from the first user 102. For example, the user 102 may provide a design file to the design module 202, wherein the design file contains and/or is indicative of a structural design. In one aspect, the design module 202 may enable the first user 102 to build or save the structural designs. In another aspect, the design module 202 may enable the first user 102 to upload designs via the user interface 203. Further, the design module 202 may also enable the first user 102 to modify the designs. As another example, the design module 202 may also enable the first user 102 to modify other designs available through the design module 202, such as designs received from another user. The design module 202 may enable the first user 102 to combine features/components of one or more designs to create a new design or modify an existing design.

Accordingly, the design module 202 may comprise a design tool to enable the first user 102 to build one or more designs. In an example, the software may be an open-source building tool, such as LeoCAD, LDraw™, or the like. As another example, the first user 102 may use other third-party software, such as AutoCAD®, PTC Creo®, SOLIDWORKS®, or the like. The first user 102 may build one or more designs using the design module 202. The software associated with the design module 202 may be used by the first user 102 to develop one or more designs in a standard format. For example, a design file indicative of a structural design may be in a standard format, which may include a proprietary format of the assistance module 200. As another example, the design module 202 may convert a design file of a different format into the standard format. In an aspect, the design module 202 may navigate to an external platform that hosts the software to enable the first user 102 to build one or more designs.

The designs, as discussed herein, may include designs for various structures and components of structures. Designs may encompass a complete structure (e.g., a building), or a component of a structure. In an aspect, the designs may further include features such as, a layout for an electrical wiring within the structures. Additionally or alternatively, the designs may include layouts for various other features, such as passageways for cabling, drainage, venting, plumbing pipes, HVAC systems, windows, doorways, and the like. Accordingly, the designs may be used to construct the physical structures that include the corresponding features therein via the 3D construction machines. The designs may also include a foundation or footer, or information relating to appropriate ground conditions onto which the material for the structure may be deposited.

In an aspect, the assistance module 200 may be configured with functions utilized in creating the designs. The design module 202 may provide information relating to a design modification (e.g., a change to the structural design) or implementation detail (e.g., how to build a structure based on the structural design) to the first user 102. Additionally or alternatively, the design module 202 may automatically incorporate the design modification or implementation detail. Alternatively, the GUI 300 (FIG. 3) may allow the first user 102 to incorporate the design modification or implementation detail into the structural design. In such a case, the design module 202 may be configured to receive design modifications or implementation details via the GUI 300 (FIG. 3).

For example, the design module 202 may identify one or more modifications of the design based on at least data received from the analytics engine 206. These modifications may include adjustments to certain measurements, such as joint angles, wall thicknesses, or the like. These modifications may be identified based on any desirable criteria, including manufacturing costs, structural integrity, heating and cooling costs of the structure, certain design requirements, or the like. Once the design module 202 identifies one or more modifications, the design module 202 may provide the modification(s) to the first user 102 as an alert, a message, or the like.

As another example, the design module 202 may determine other implementation details. Implementation details may include any aspect or detail of actually implementing a structure based on the structural design. The implementation details may include location information for the building, such as the positioning or orientation of the structure. The location information may be identified by the design module 202 based on any desirable criteria, including manufacturing costs, structural integrity, heating/cooling costs of the structure, certain design requirements, or the like. Once the design module 202 identifies one or more implementation details, the design module 202 may provide these criteria to the first user 102 as an alert, a message, or the like.

In one example, the design module 202 may determine one or more modifications or implementation details based on the inclusion of solar panels in a structural design. As a design modification, the design module 202 may determine a roof angle or pitch to increase the amount of sunlight exposure of the solar panel. As an implementation detail, the design module 202 may determine a rotation or orientation of the building based on the structural design to increase the amount of sunlight exposure of the solar panel.

The design module 202 may use one or more components of the assistance module 200 to design a structure such that it may be powered by a photovoltaic component, which may be included in a micro-grid. A micro-grid is a localized grouping of electricity sources and energy storage configured to power a local load without the need for connecting the load to the traditional electrical grid. In an aspect, a structure powered by a micro-grid may or may not be connected to the traditional electrical grid. For example, a structure may include enough solar panels to power the entire structure, including any subsystems thereof.

The analytics engine 206 analyze the structural design to determine whether a building based on the design may be fully or partially powered by a micro-grid based on the electrical characteristics of the structural design. This may be based on, for example, electrical wiring plans received or developed at the design module 202. The analytics engine 206 may also assign a power level for a structural design, such as a building or an associated part, for example, a roof, based on at least a size of the roof. As an example, the power level may include a potential energy load expected for the structure based on comparable structures or the number of electrical outlets, for example. The power level may include a potential power generation capacity based on the area to receive photovoltaic or an angle relative to the sun's position in the sky or average wind speeds, and the like.

The analytics engine 206 may rely on electrical characteristics, power levels, positioning of the structure, or any other information to evaluate whether the structural design may be configured for use with a micro-grid or a power system. For example, the analytics engine 206 may determine whether the location of the structure is outside the reach of another existing micro-grid and that the existing micro-grid has excess capacity that could power the building. The analytics engine 206 or the design module 202 may provide an alternative positioning of the structure that would place the structure in electrical communication with the existing micro-grid. Other factors that affect the viability of powering the structure based on at least the design and its location, including environmental factors, may be considered. For example, the analytics engine 206 may consider expected weather of the location as well as potential blockages to sunlight, like other structures, geographical features, foliage, or the like. Based on at least one or more of these factors, the analytics engine 206 may determine that the structure may be powered by the micro-grid, the structure is unlikely to be able to meet its power requirements based on at least the micro-grid, a design modification will make the structure more capable of being powered on the micro-grid, or a location/position modification will make the structure more capable of being powered on the micro-grid, or the like. Other system components such as photovoltaic cells, controllers, energy storage device, inverters, wind turbines, and the like may be managed in a similar manner, whereby the analytics engine 206 provides suggested structural placement of these components to effect certain desired outcomes such as maximizing power generation, for example.

The analytics engine 206 or the design module 202 may include or be communicatively coupled to the sorting module 204. The sorting module 204 may be configured to sort each of the designs into a category based on at least the type of the physical structure associated with the designs. For example, the category may include a building type. For example, a building category may encompass a single-family home type, a multi-family home type, a but type, a silo type, a decorative archway type, a column type, a pavilion type, a pergola type, a gazebo type, a porch type, a water feature type, a water storage type, a fortification, a storage building type, a shed type, a shelter, a multi-story building type, a cellar type, a masonry oven type, an animal housing type, a barrack type, or a garage type, or the like. These subcategories may be grouped generally as a building type. Additionally or alternatively, components may be categorized based on at least more specific categories, such as categories devoted to a specific type of building (e.g., single-family home).

Additionally or alternatively, the category may include a part or a component of the physical structure, for example a component category may encompass a roof, wall, ceiling, column, support beam, staircase, chimney, building expansion, such as an add-on porch, or any other portion of a building or structure. These components may be grouped generally as a component type. Additionally or alternatively, components may be categorized based on at least more specific categories, such as categories devoted to a specific type of component (e.g., roof).

The sorting module 204 may sort a design into one or more categories or subcategories. Categories and subcategories may be based on at least any feature of a structure, including aesthetics, designs that can be made out of a certain type of material, designs that are appropriate for certain geographic areas/climates, designs having certain uses, designs having certain electrical requirements, design or manufacturing cost, or any other feature that may be considered by a builder or consumer when searching for designs. Categories and subcategories can be based on at least a design style (e.g., Tudor), how long it takes for an additive manufacturing machine to extrude the design, the type of additive manufacturing machine or machine components required, whether the design can be packaged (e.g., flat packed) for transport and assembled at its destination, or the like. Categories and subcategories can be based on at least factors that may be relevant to the ultimate owner, such as an estimated cost of heating or cooling the structure, the power requirements of the structure, or any other feature. For example, a design for a single-family home that is designed to be or capable of being mounted on stilts may be included in a hurricane-proof category, a building category, or a single-family home category.

A structural design received through the user interface 203 or developed using the design module 202, including any modifications thereof, may be provided to the analytics engine 206. The analytics engine 206 may be configured to analyze a structural criterion of the design. The analysis may be based on at least one criterion or multiple criteria. For example, the structural criteria may include one or more of a strength criterion, a cost criterion, an aesthetic criterion, a material grade, or a combination thereof. An example combination may include multiple strength criteria, a cost criterion, and multiple aesthetic criteria. Any combination of structural criteria, including a single criterion, is within the scope of this disclosure.

Structural criteria may include any objective or subjective criteria relating to the design. The structural criteria may be standard for all designs. For example, structural criteria may include strength criteria. Additionally or alternatively, the structural criteria may be dependent on one or more features of the design. Structural criteria or structural analysis of a silo may use different factors or formulas to perform structural analysis than would be used for structural analysis of a but or a wall. Structural criteria or structural analysis of a component or complete design may include known structural properties (e.g., stress, strain, failure, etc.) of cured materials (e.g., based on a defined cure time). Other consideration such as material properties of an infill material, thickness, placement angle, loads, an environmental conditions may be used to determine a structural value.

The analytics engine 206 may analyze the strength criteria by performing structural analysis on the designs. Structural analysis may be performed based on generally known structural analysis methods. The structural analysis may be based on one or more fundamental relations, such as equilibrium, constitutive, or compatibility. For example, the structural analysis may use simple linear elastic models or more complex differential equations to examine one or more of support reactions, stresses, and displacements. The structural analysis methods may make use of one or more of the mechanics of materials approach, the elasticity theory approach, or numerical approximation, such as the finite element approach. One or more types of analysis may be performed to evaluate the strength criteria, including those used in materials science, construction engineering, earthquake engineering, mechanical engineering, or civil engineering applications. The strength criterion may be evaluated via a panel of experts, where the results may be aggregated to determine a final strength value for the particular design.

Strength criteria may include multiple types of criteria in addition to or instead of structural analysis methods that are generally known. For example, strength criteria may consider the different types of environments or climates a design is appropriate for. For example, this type of analysis may consider factors related to how insulated a design is (e.g., based on at least the thickness or materials of outer walls); how well it can withstand rain, high winds, flooding, earthquakes, or any combination thereof; how well it can withstand certain environmental materials, such as sand, acid rain, or other forms of pollution; how much weight, volume, or other measurement of load the design may handle (e.g., storage capability of a silo or the maximum weight of snow a roof can withstand); or any combination thereof. Any criteria related to the strength or durability may be considered.

The analytics engine 206 may approve the design if the corresponding design passes the associated strength criteria. Accordingly, these designs may be included in a list of approved designs for the associated first user 102. Moreover, the designs that have passed the structural analysis may be uploaded to the database 106 for display to the second users 104. The analytics engine 206 may determine the design as not approved if the corresponding design fails the associated strength criteria requirement. For example, if the strength criteria of the design do not meet the minimum requirements, the first user 102 may be notified. In an aspect, the design module 202 may receive a modification of the structural design from the first user 102. In another aspect, the design module 202 may propose a modification of the structural design to the first user 102. The user may modify the structural design using the design module 202 through the user interface 203. The user may modify the structural design in the standard format, regardless of the format the design was first provided by the first user 102. In another aspect, the design module 202 may be configured to automatically modify the design to improve the structural criteria of the design.

The structural criteria may include other criteria in addition to, or instead of, the strength criteria. Structural criteria may include cost criteria. Cost criteria may relate to the cost of manufacturing the design. For example, the cost criteria may consider the cost of materials, labor costs, the cost of equipment rental, or any combination thereof. The cost criteria may factor in differences in cost based on at least the location of the structure to be manufactured based on at least the design. The cost criteria may factor in shipping costs. The cost criteria may include overall quality of the design. Designs that are meant to last for decades, for example, may have better quality criteria than designs for structures that will not last as long under the same conditions. Cost criteria may consider whether the design includes or is capable of certain modifications to decrease the cost. For example, that a design that is available in a grade A material but can also be manufactured in a grade B material may be considered in developing the cost criteria of the design. In an aspect, a more cost-effective design may have better cost criteria than a similar design that is more costly. As another example, designs that provide the most quality for the cost may have better cost criteria. As another example, the lowest-cost designs may have more favorable criteria. Any methodology for determining and weighing factors that may be directly or indirectly related to cost associated with the design may be considered in determining the cost criteria of a design.

The structural criteria may include material grade. Material grade may be considered instead of, as part of, or separately from cost criteria. For example, designs to be made in a higher grade material may have a better or worse material grade criteria than designs made in a lower grade material. Additionally or alternatively, the variety of materials or range of material grades available may be factored into the analysis. Structural criteria related to the material grade may factor in the variety of materials used to manufacture a structure based on at least the design. It may factor in the general availability of the material to be used to manufacture a structure. For example, a material grade may be improved if the design uses generally available materials, as opposed to specialty products. As a specific example, the material grade of a design may be lower if the design requires materials or component parts that must be specially ordered. Any methodology for determining and weighing factors that may be directly or indirectly related to material grade associated with the design may be considered in determining the material grade of a design. As an example, various material compositions (e.g., loadings of components in the composition) may be known to increase strength or wear properties, but may affect the overall cost of the structure. Thus, options may be provided to a user to balance the strength and cost. As a user selects such options, the weight factors used by the analytics engine 206 may be adjusted to reflect the customized options selected by the user. Such options may include strength, speed, cost, and grade (e.g., military grade, hurricane grade, etc.), for example.

The structural criteria may include aesthetic criteria. For example, this criteria may be based on at least how universally pleasing a design is. These criteria may consider whether this design is aesthetically popular in only a small region. The criteria may consider how well the aesthetics of a design will age based on at least wear and tear of the structure during use. The aesthetic criteria may be based on at least how trendy or classic a design is. For example, while split-level houses were popular designs in the past, their popularity may have significantly decreased over time, while ranch-style houses may maintain a steadier popularity. The aesthetic criteria may consider how in-style the aesthetics of the design may be at present, or how popular the style it is expected to be in the future. Any methodology for determining and weighing factors that may be directly or indirectly related to aesthetics associated with the design may be considered in determining the aesthetic criteria of a design. As an example, the aesthetic criteria may be adjusted based on a selected surface treatment or finishing options. As a further example, grooves, polish, lattice, and other surface designs or treatments may be inputted by the designer and/or may be applied to base designs.

The analytics engine 206 may also be configured to determine other parameters related to each of the designs. In an aspect, the analytics engine 206 may be configured to determine an amount of material required for the 3D construction of the design. The analytics engine 206 may also be configured to determine a time required to extrude the material for the physical construction of the 3D construction of the design. Further, such parameters may be stored in the database 106 as discussed above.

The analytics engine 206 is further configured to assign the structural value to each of the designs. For example, the designs that have passed the strength criteria may be assigned the structural value. In an example, the structural value may be a parameter on which a royalty for the design may be calculated. In another example, the structural value may be based on at least a cost of the design. The analytics engine 206 may assign the structural value based on at least the analysis of the strength criteria of the design. The structural value may be assigned further based on at least various other parameters such as, a time for the 3D printing machine to complete the extrusion, the material used for the construction, cost of the material and others. In an example, the analytics engine 206 may also assign the structural value further based on at least popularity for the design. Similarly, the analytics engine 206 may update the structural value based on at least the popularity of the design indicated by the number of sales of the design. The structural value may be a numeric value such as on a scale of 1 to 100 or may be a categorical value such as “economy,” “basic,” “high-end,” and “Luxury,” or the like. Other values may be used to define the scope and representation of the structural value.

The assistance module 200 may be configured to receive feedback for a design. For example, this feedback may include information that a single-family home built based on at least the design was able to withstand more snow than previously thought without the roof caving in. Additionally or alternatively, this feedback may be subjective. A builder may indicate that he/she did not like the aesthetics of the design, or that in application, the aesthetics were not what was expected based on at least the design file. The analytics engine 206 may factor in this feedback when determining a structural value of the design. Additionally or alternatively, the design module 202 may be configured to present options for modification of the structural design based on at least feedback data.

The analytics engine 206 may analyze the structural design to determine what ancillary components are required by the design. In an aspect, the analytics engine 206 may determine whether such ancillary components that would meet the design requirements are available. For example, the analytics engine 206 may determine that based on at least the width of a doorway that a standard door would not fit in the design. The analytics engine 206 may provide one or more modifications to the design so that it only requires ancillary components that are available. The analytics engine 206 may identify different options for certain ancillary components. For example, the analytics engine may identify one or more doors from one or more merchants, resellers, third-party providers, sellers, venders, or the like that would be able to be incorporated into the structure. The analytics engine 206 may associate the ordering information for the ancillary component with the structural design, wherein the ordering information is based on at least the third-party provider. The analytics engine 206 may also determine when certain ancillary products are discontinued, on backorder, or not available in the geographic location in which the structure is to be built. The analytics engine 206 may determine different cost options for different types of ancillary products. The analytics engine 206 may provide a design modification based on at least an availability of an alternative ancillary component, if, for example, the ancillary component in the current design is not available. This information may be used by the first user 102 to modify the design. The availability, cost, or variety of ancillary components may factor into the structural analysis and may impact the structural value of the design.

Additionally or alternatively, the analytics engine 206 may allow expert users or other first users 102 to analyze the designs. In such a case, the analytics engine 206 may assign the structural value further based on at least the analysis by the expert users or the other first users 102. In an aspect, the analytics engine 206 may also be configured to assign a value points to the first user 102 based on at least a number of accepted designs and associated structural value, expertize, productivity, or other parameters.

As shown, the assistance module 200 is also in communication with the second user 104. The assistance module 200 may allow the second user 104 to provide one or more user inputs via the GUI 300. The display module 208 may be configured to allow the second user 104 to view each of the designs along with the associated category and the structural value.

The display module 208 may be configured to display the design selected by the second user 104 on the GUI 300. In an aspect, the assistance module 200 may allow the second user 104 to view the designs based on at least an authentication for example, security credentials provided by the corresponding second user 104. As illustrated, the output on the GUI 300 may include a design number, a category of the design, amount of material used, structural value, cost of the design, time to extrude the material, or the like. Further, the GUI 300 may also include control elements 302, 304 that may allow the user to provide input corresponding to viewing the design.

The control element 302 may allow the second user 104 to provide input corresponding to selecting view options related to the design. The view options may include options such as, zoom, pan, 3D rotate, or the like. The view options may also include viewing the design at various standard viewing angles such as, rear, front, left, top, bottom, isometric or the like. In an aspect, the view options may also include viewing the design based on at least dynamic view angles. For example, the view options may include viewing a roof, interiors, or the like of the structure, or viewing the design from various angles or orientations. The control element 304 may allow the second user 104 to provide input corresponding to viewing the design in 3D view.

The selecting module 210 may be configured to receive an input from the second user 104 to select one or more designs. In an aspect, the GUI 300 of the assistance module 200 may allow the user to provide input corresponding to selection of one or more designs. In the illustrated aspect, the GUI 300 includes a control element 306 that may allow the second user 104 to provide input corresponding to the selection of the particular design. In an aspect, the GUI 300 of the assistance module 200 may also allow the second user 104 to select parts of one or more designs. The GUI 300 may allow the second user 104 to select any of the design files, such as the designs received from the first user 102, the designs stored in the database 106, designs received through other third party sources, or the like.

The building module 212 may be configured to receive an input from the second user 104 to build the virtual structure using the selected designs. The assistance module 200 may be associated with suitable software that may allow the second user 104 to build the virtual structure using a combination of the selected designs. In an example, the assistance module 200 may allow the second user 104 to build the virtual structure of a house using a design of a solar roof. In one example, the software may be integrated with the assistance module 200 so as to enable the second user 104 to build the virtual structure. In another example, the building module 212 may redirect to the corresponding software that may be hosted on other third party platforms.

Accordingly, the display module 208 may be in communication with the building module 212 to display the virtual structure via the GUI 300. Further, the building module 212 may also allow the second user 104 to modify the virtual structure by replacing the existing designs with other designs.

The transform module 214 may be configured to transform the selected designs into a predefined format. In an aspect, the transform module 214 may be configured to integrate each of the selected designs into a single design and further transform the design into the predefined format. The transform module 214 may be configured to receive the structural design in the first format from the design module 202 and convert the structural design into a second format. For example, the transform module 214 may slice the design layer-by-layer into a format that can be used by an additive manufacturing machine to extrude, manufacture, or 3D print the structure.

The download module 216 may allow the second user 104 to download the selected designs in the predefined format. The predefined format enables the processing of the selected designs into the physical structure through the 3D construction process. In an aspect, the predefined format may have a file extension that may be accessed by a predetermined type of 3D construction machine. In an example, the design files in the predefined format may be only accessed by 3D construction machines that are associated with a particular company for example, XYZ company. The analytics engine 206 is further configured to determine a royalty associated with the selected designs based at least in part on the structural value and one or more parameters. The analytics engine 206 may be in communication with the download module 216 to determine the designs that are selected for download. Accordingly, the analytics engine 206 may calculate the royalty for each of these selected designs. In an example, the royalty may be determined in terms of money. In another example, the royalty may be determined in terms of the structural values.

The payment module 218 may allow the second user 104 to make necessary payments that may be required to download the selected designs. In another aspect, the payment module 218 may be integrated with 3D construction machines that are used to build the physical structures based on at least the selected designs. Accordingly, the payment module 218 may allow the second user 104 or other users to make the necessary payments to use the downloaded designs with the 3D construction machines. In such an arrangement, the assistance module 200 may be in communication with the payment module 218 or the associated 3D construction machine. Further, the analytics engine 206 may accordingly calculate a payment value for the corresponding first users 102 based on at least a number of times the downloaded design is used and the royalty associated with the design.

In an aspect, the assistance module 200 may also allow the second user 104 to view ancillary components associated with each of the designs. For example, the ancillary components may include a doorway, window lintel, hinges, fasteners, or the like that may be designed to be partially or completely encompassed by the extruded material during the 3D construction. Further, the assistance module 200 may allow the second user 104 to select or purchase the ancillary components. Accordingly, the assistance module 200 may be associated with third-party dealers or companies that sell the ancillary components. In an aspect, the assistance module 200 may render or load a purchase interface of the third-party dealer to facilitate the second user 104 to purchase the ancillary components. In another aspect, the purchase interface of such dealers may be integrated with the assistance module 200 thereby facilitating the second user 104 to purchase the ancillary components via the GUI 300 of the assistance module 200.

In an aspect, the assistance module 200 may also provide details related to different dealers, for example, local representatives of an XYZ company that can provide assistance related to 3D construction machines, 3D construction process, or the like. Additionally or alternatively, the GUI 300 may allow the second user 104 to communicate with these dealers for receiving the required assistance, such as an availability of the 3D construction machines, details of the processes, or the like. In an example, the assistance module 200 may also allow the second user 104, via the GUI 300, to select the dealer or the 3D construction machine for use in building the physical structure corresponding to the downloaded design.

A person of ordinary skill in the art will acknowledge that the GUI 300 and the corresponding graphical control elements explained with reference to FIG. 3 are merely exemplary in nature and hence non-limiting of this disclosure. Moreover, design or functional modifications may be possible for the GUI 300 without deviating from the scope of the present disclosure.

Further, the environment 100 described above is to be considered as merely example and hence non-limiting of this disclosure. Moreover, the environment 100 may include any number of the databases 106, first users 102, second users 104, or networks 110. Although, the assistance module 200 is described to include multiple modules carrying different functions, it may be contemplated to include a single module, lesser number of modules, or even additional modules to implement the functions that are described herein.

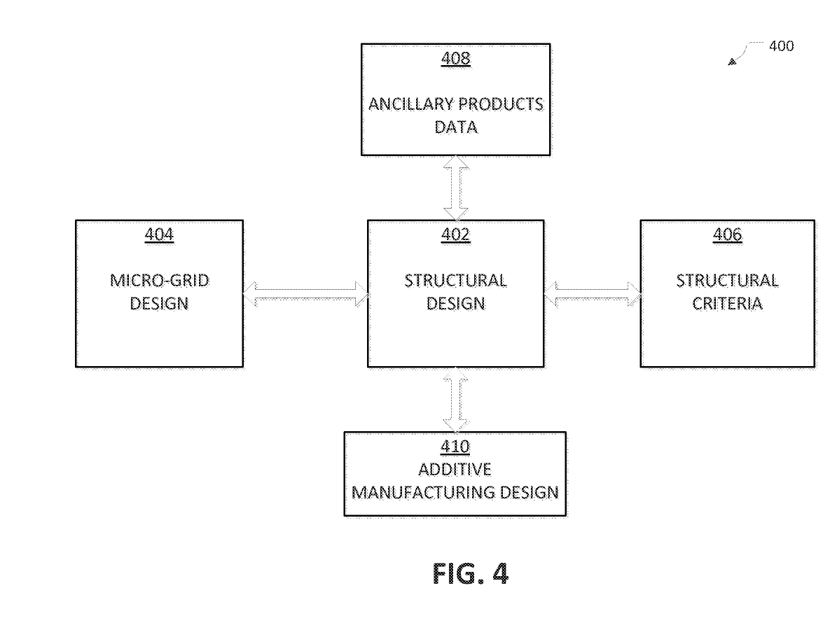

FIG. 4 provides an exemplary data flow 400 for the assistance module 200. The data flow 400 may include a structural design 402, a micro-grid design 404, structural criteria 406, ancillary products data 408, and an additive manufacturing design 410. For example, the structural design 402 includes a design of a structure or a component of a structure. The structural design 402 may be indicative of a design submitted or modified by one or more users such as the first user 102. For example, the assistance module 200 may receive the structural design 402 at the design module 202. As a further example, the structural design 402 may be attributed to one or more designers contributing to the creation (e.g., generation, modification, etc.) of the structural design 402.

The micro-grid design 404 includes a design feature or implementation detail that incorporates micro-grid powering into the structural design. For example, the micro-grid design 404 may include one or more modifications to the structural design 402 to enable the structure based on the structural design to incorporate electricity generators, such as solar panels. Additionally or alternatively, the micro-grid design 404 may include electrical wiring designs to connect a structure to another micro-grid, such as one in already in place at the build site. The micro-grid design 404 may be based on at least the structural design 402. For example, the dimensions and other elements in the structural design 402 may be used to determine whether the structure may be powered on the micro-grid and, if so, how. Further, the micro-grid design 404 may influence the structural design 402. For example, a modification of the structural design 402 may be implemented to accommodate a requirement of the micro-grid design 404. In this matter, the micro-grid design 404 may both be based on at least and influence the structural design 402.

The ancillary products data 408 may include any information related to ancillary components, materials, or tools used in the manufacture of a building based on the structural design. This could include parts lists, supplier lists, or the like. The ancillary products data 408 may be rendered based on at least data from the structural design 402. Similarly, the ancillary products data 408 may be considered when modifying the structural design 402, for example, to provide sufficient support or spacing for particular ancillary products. Ancillary products may include picture windows, doors, archways, and the like. As such, modifications to the structural design 402 may be provided to ensure proper support or spacing for such products. In this matter, the ancillary products data 408 may both be based on at least and influence the structural design 402.

The structural criteria 406 may include any information or factors to be considered in analyzing the structural design 402. For example, the structural criteria 406 may include formulas, data, or characteristics related to the structural design 402. The structural criteria 406 may be determined based on at least analyzing the structural design 402. For example, the structural design 402 may be analyzed to determine its structural integrity. These structural criteria 406 may then be used to identify a structural value of the structural design 402. Similarly, the structural criteria 406 may be used to improve or otherwise modify the structural design 402. In this matter, the structural criteria 406 may both be based on at least and influence the structural design 402.

The additive manufacturing design 410 may be a design file in a format that can be used by an additive manufacturing machine to build a structure based on the structural design 410 in a layer-by-layer format. The structural design 402 may be used to create the additive manufacturing design 410. Additionally or alternatively, modifications of the additive manufacturing design 410 may be used to modify the structural design 402. In this matter, the additive manufacturing design 410 may both be based on at least and influence the structural design 402. In certain aspects, when the additive manufacturing design 410 is generated, a notification may be transmitted to a source of the associated structural design 402, such as a one or more users contributing to the creation of the structural design 402.

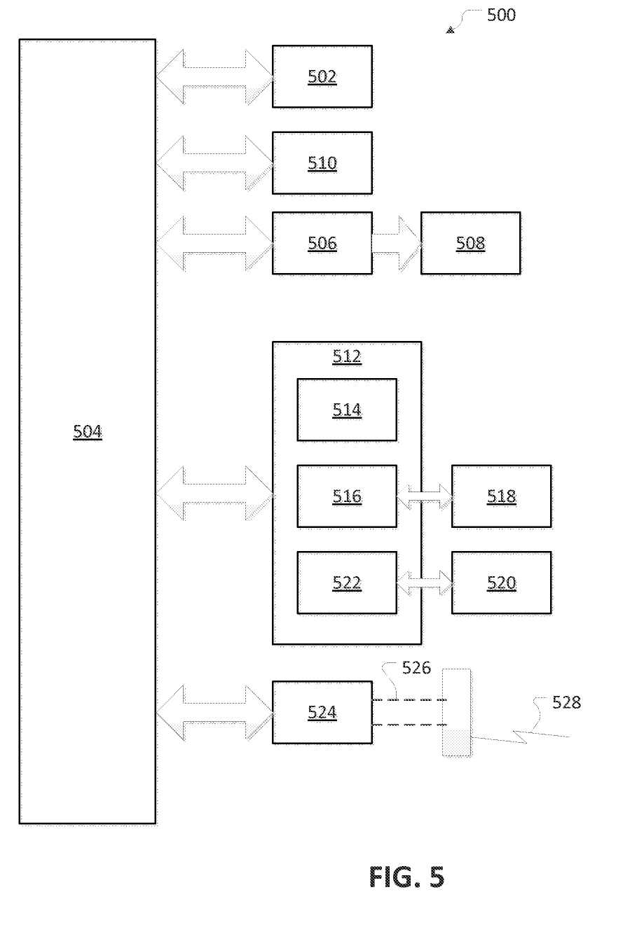

In accordance with an aspect of the present disclosure, the present disclosure is directed towards one or more computer systems capable of carrying out the functionality described herein. An example of the computer-based system includes a computer-based system 500, which is shown by way of a block diagram in FIG. 5.

The computer-based system 500 includes at least one processor, such as a processor 502. The processor 502 may be connected to a communication infrastructure 504, for example, a communications bus, a cross-over bar, a network, or the like. Various software aspects are described in terms of this example computer-based system 500. Upon perusal of the present description, it will become apparent to a person skilled in the relevant art(s) how to implement the present disclosure using other computer systems or architectures.

The computer-based system 500 includes a display interface 506 that forwards graphics, text, or other data from the communication infrastructure 504 or from a frame buffer (not shown) for display on a display unit 508.

The computer-based system 500 further includes a main memory 510, such as random access memory (RAM), and may also include a secondary memory 512. The secondary memory 512 may further include, for example, a hard disk drive 514 or a removable storage drive 516, representing a floppy disk drive, a magnetic tape drive, an optical disk drive, etc. The removable storage drive 516 reads from or writes to a removable storage unit 518 in a well-known manner. The removable storage unit 518 may represent a floppy disk, magnetic tape, or an optical disk, and may be read by and written to by the removable storage drive 516. As will be appreciated, the removable storage unit 518 includes a computer usable storage medium having computer software or data stored therein.

In accordance with various aspects of the present disclosure, the secondary memory 512 may include other similar devices for allowing computer programs or other instructions to be loaded into the computer-based system 500. Such devices may include, for example, a removable storage unit 520, and an interface 522. Examples of such may include a program cartridge and cartridge interface (such as that found in video game devices), a removable memory chip (such as an erasable programmable read only memory (EPROM), or programmable read only memory (PROM)) and associated socket, and other removable storage units and interfaces, which allow software and data to be transferred from the removable storage unit 520 to the computer-based system 500.

The computer-based system 500 may further include a communication interface 524. The communication interface 524 may allow software or data to be transferred between the computer-based system 500 and external devices. Examples of the communication interface 524 include, but may not be limited to a modem, a network interface (such as an Ethernet card), a communications port, a Personal Computer Memory Card International Association (PCMCIA) slot and card, or the like. Software or data transferred via the communication interface 524 may be in the form of a number of signals, hereinafter referred to as signals 526, which may be electronic, electromagnetic, optical or other signals capable of being received by the communication interface 524. The signals 526 may be provided to the communication interface 524 via a communication path (e.g., channel) 528. The communication path 528 carries the signals 526 and may be implemented using wire or cable, fiber optics, a telephone line, a cellular link, a radio frequency (RF) link, or other communication channels.

In this document, the terms “computer program medium” and “computer usable medium” are used to generally refer to media such as the removable storage drive 516, a hard disk installed in the hard disk drive 514, or the like. These computer program products provide software to the computer-based system 500. The present disclosure is directed to such computer program products.

Computer programs (also referred to as computer control logic) may be stored in the main memory 510 or the secondary memory 512. The computer programs may also be received via the communication infrastructure 504. Such computer programs, when executed, enable the computer-based system 500 to perform the functions consistent with the present disclosure, as discussed herein. In particular, the computer programs, when executed, enable the processor 502 to perform the features of the present disclosure. Accordingly, such computer programs represent controllers of the computer-based system 500.

In accordance with an aspect of the present disclosure, where the disclosure is implemented using a software, the software may be stored in a computer program product and loaded into the computer-based system 500 using the removable storage drive 516, the hard disk drive 514, or the communication interface 524. The control logic (software), when executed by the processor 502, causes the processor 502 to perform the functions of the present disclosure as described herein.

In another aspect, the present disclosure is implemented primarily in hardware using, for example, hardware components, such as application specific integrated circuits (ASIC). Implementation of the hardware state machine to perform the functions described herein will be apparent to persons skilled in the relevant art(s). In yet another aspect, the present disclosure is implemented using a combination of both the hardware and the software.

Various aspects disclosed herein are to be taken in the illustrative and explanatory sense, and should in no way be construed as limiting of the present disclosure. All numerical terms, such as, but not limited to, “first” and “second” or any other ordinary or numerical terms, should also be taken only as identifiers, to assist the reader's understanding of the various aspects, variations, components, or modifications of the present disclosure, and may not create any limitations, particularly as to the order, or preference, of any aspect, variation, component or modification relative to, or over, another aspect, variation, component or modification.

It is to be understood that individual features shown or described for one aspect may be combined with individual features shown or described for another aspect. The above described implementation does not in any way limit the scope of the present disclosure. Therefore, it is to be understood although some features are shown or described to illustrate the use of the present disclosure in the context of functional segments, such features may be omitted from the scope of the present disclosure without departing from the spirit of the present disclosure as defined in the appended claims.

### INDUSTRIAL APPLICABILITY

The disclosed systems and methods may be integrated into a universal platform for designers to design, modify, and submit designs for structures built with additive manufacturing techniques. Submitted designs may be analyzed based on a number of criteria. For example, the designs may be analyzed to ensure minimum requirements are met before the designs may be available for use. Additionally or alternatively, the designs may be analyzed based on other criteria. Specific implementation details or modifications may be identified and provided to the designers or associated with the designs based on the analysis.

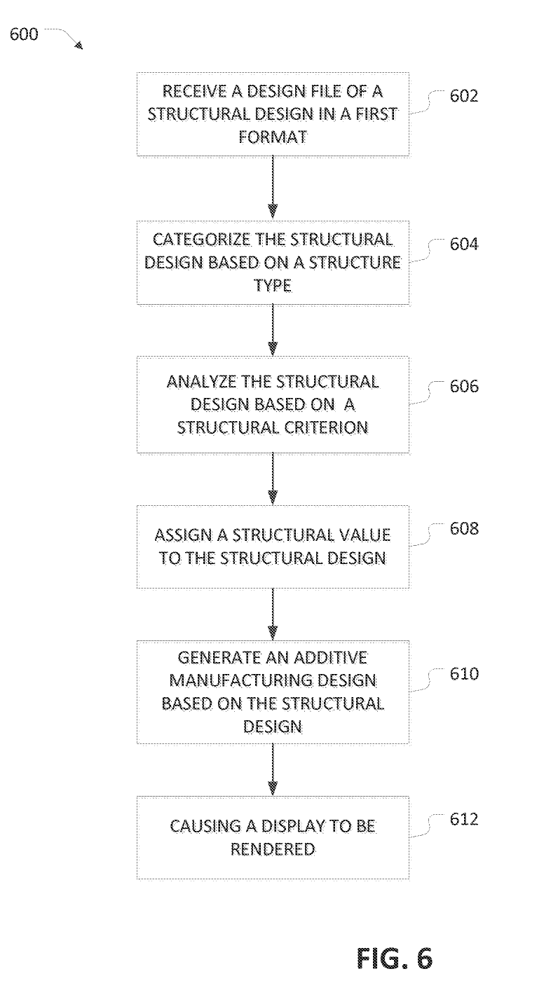

FIG. 6 illustrates an exemplary method 600. In an aspect, one or more steps of the method 600 may be implemented using the environment 100 described above. For example, one or more of the steps of the method 600 may be performed by one or more of the design module 202, the sorting module 204, the analytics engine 206, or the like. It should be noted that although FIG. 6 shows a specific order of the steps, it is understood that the order of these steps may differ from what is depicted. Also two or more steps may be performed concurrently or with partial concurrence. Further, it should be noted that some steps are optional and may be omitted. It is understood that all such variations are within the scope of this disclosure.

Step 602 may include receiving a design file of a structural design in a first format. As discussed above, this design file may be created or modified within the assistance module 200. In an aspect, the design file may have been created in a different system and then uploaded to the assistance module 200. The design file may be for a structure or a component of a structure to be manufactured using additive manufacturing methods. As an example, the design file may be for a structural design of a single-story building.

Step 604 may include categorizing the structural design. The structural design may be categorized based on at least a structure type, such as a building type or a component type. The structural design may be categorized into multiple categories, including subcategories. For example, the single-story building may be categorized into one or more of the following categories: building, single-story building, or a single-family home.

Step 606 may include analyzing the structural design based on at least a structural criterion. This step may include any type or combination of structural criterion. The analysis may depend upon the strength, aesthetics, cost, material, or the like. The structural analysis may be based on generic criteria. Additionally or alternatively, the structural criteria may depend upon one or more features or characteristics of the structure. The structural criteria may be dependent upon the category that includes the structural design. For example, the single-story building may be evaluated based on criteria relating to the different uses for the building, the structural integrity of the roof, or the durability of the materials.

Step 608 may include assigning a structural value to the structural design based on at least the structural criterion. The structural value may weigh the structural criterion in any manner. For example, the structural value of the single-story building may be favorably impacted based on the building having multiple uses and negatively impacted because the materials selected for the design are not durable. In an aspect, the structural value may weigh more heavily the durability of the materials; such as if a stated intended use of the building would expose the building to harsh environments, such as a desert climate.

Step 610 may include generating an additive manufacturing design based on at least the structural design. This may include, for example, formatting the single-story building design into a format that, when read by a 3D manufacturing machine, causes the machine to extrude or build at least a portion of the single-story building. This may include changing the format of the structural design file. Reformatting may include slicing the design layer-by-layer, similar to the manner in which a 3D manufacturing machine would extrude or build a structure based on the design. In certain aspects, a notification may be transmitted to the source of the structural design, when the additive manufacturing design is generated.

Optionally, the method 600 may include causing a display to be rendered at step 612. The display may include a 3D representation of the structural design. The display may also include information related to the structural design, including the structural criterion or the structural value.

With such an implementation of the assistance module 200 or the method 600, various first users 102, such as, for example, independent designers, structural engineers, or any other users may build designs or upload their designs for purchase to a large number of potential purchasers. Further, the present disclosure also enables performing structural analysis of these designs to determine if the designs have a sufficient structural integrity to build the physical structure.

Further, the present disclosure also provides the interface for the second users 104, for example, customers, dealers, builders, construction companies, or the like to view and select one or more of these designs. Additionally or alternatively, the assistance module 200 and the method 600 enable the second user 104 to build and view the virtual structure using the designs in various views such as, 3D, perspective and the like. Further, the designs may be converted into a format that can be readily uploaded to the 3D construction machine to further build the physical structure.

Additionally, the present disclosure also facilitates determining royalty for the designs based on at least the usage of these designs by the second users 104 and other parameters. Accordingly, the payment to be paid to the first users 102 may also be decided.

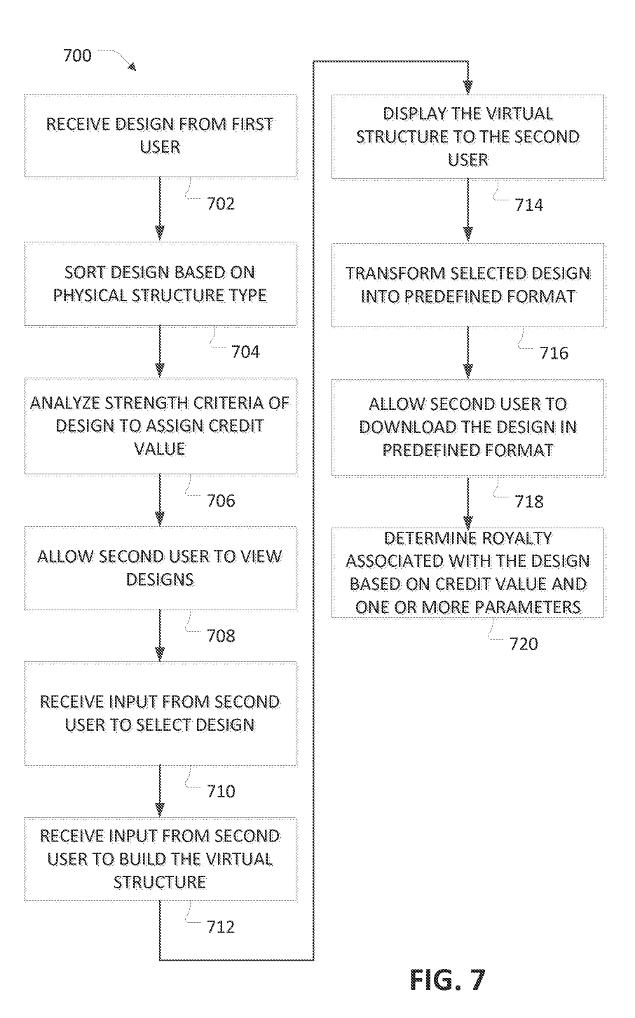

FIG. 7 illustrate a flowchart for a method 700 for enabling users to select one or more designs for 3D construction of the physical structure, according to an aspect of the present disclosure. In an aspect, one or more steps of the method 700 may be implemented using the environment 100 described above. It should be noted that although FIG. 7 shows a specific order of the steps, it is understood that the order of these steps may differ from what is depicted. Also two or more steps may be performed concurrently or with partial concurrence. Further, it should be noted that some steps are optional and may be omitted. It is understood that all such variations are within the scope of this disclosure.

Step 702 may include receiving the one or more designs from the first users 102. In one aspect, step 702 may include receiving a design file uploaded by the first user 102. In another aspect, the first user 102 may use the assistance module 200 to create or modify a design. As an example, the first user 102 may upload a design for a silo.

Step 704 may include sorting each of the designs into a category. The structural design may be categorized based on at least a structure type, such as a building type or a component type. The structural design may be categorized into multiple categories, including subcategories. For example, the silo may be categorized into one or more of the following categories: building, silo, or storage facility.

Step 706 may include analyzing the strength criteria for each of the designs to assign the credit value to each of the designs. The analysis may include an initial analysis to determine whether the design passes associated strength criteria. The analysis may be based on one or more criteria, such as criteria specific to the one or more categories associated with the design. The credit value may be based on strength criteria, aesthetics, materials, cost, design popularity, amount of material used for constructing the corresponding physical structure, time for extruding the material, or any other feature of the design. The credit value may be based on feedback received from implementation of the design or from third parties. For example, the silo may be assigned a credit value based on the volume or weight of storage the silo can hold, the expected lifespan of the silo, and the popularity of the design compared to other silo designs.

Step 708 may include allowing the second user 104 to view each of the designs, the associated category, and the credit value. The second user 104 may search through and evaluate the designs based on the design, the structural analysis, the credit value, or the category to which the design is assigned. The second user 104 may view details related to the design, such as materials, dimensions, costs, components, tools, or the like. In an example, step 708 may provide search results including the silo design based upon a query for grain storage structures.

Step 710 receiving an input from the second user 104 to select at least one design. For example, the second user 104 may select the silo design after comparing the structural criteria of the silo design to other designs. Step 710 may include the second user 104 selecting different portions of different designs. For example, the second user 104 may select the silo design but modify the roof of the silo based on a second silo design.

Step 712 may include receiving an input from the second user 104 to render the virtual structure using the selected designs. The assistance module 200 may be associated with a suitable visualization software that may allow the second user 104 to view a three-dimensional representation of the structural design. This may include rendering a representation of a design comprising different components of multiple designs, or including additional features. For example, step 712 may include rendering solar panels on the silo.

Step 714 may include displaying the virtual structure to the second user 104. The assistance module 200 may display the virtual structure on an associated display screen. This display may constitute a three-dimensional representation of the design. The second user 104 may interact with the three-dimensional image, such as by zooming, panning, tilting, rotating, or otherwise manipulating the view of the design.

Step 716 may include transforming the selected designs into a predefined format. The selected design may be formatted such that it may be used by an additive manufacturing machine to extrude or manufacture at least a portion of the structure in a layer-by-layer format. The predefined format enables the processing of the selected designs into the physical structure through the 3D construction process. In an aspect, the predefined format may have a file extension that may be accessed by a predetermined type of 3D construction machine. In an example, the design files in the predefined format may be only accessed by the 3D construction machines of an XYZ company. The additive manufacturing machine-readable format may be associated with the three-dimensional representation of the design rendered in step 714

Step 718 may include allowing the second user 104 to download the selected designs in the predefined format. For example, the second user 104 may purchase or license the selected design. The downloaded format may be provided to the additive manufacturing machine for actual building of a structure based on the structural design. Step 718 may require that the second user 104 pay a royalty or fee to download the formatted design.

Step 720 may include determining a royalty associated with the selected designs based at least in part on the credit value or another parameter. This may include associating any collected royalties with the design from which the royalties were originated. This may further include transferring payment to the designer of the designs.

With such an implementation of the method 700, various first users 102, such as, for example, designers, structural engineers, or any other users may build designs or upload their designs for purchase to a large number of audience. Further, the present disclosure also enables performing structural analysis of these designs so as to determine if the designs have a sufficient structural integrity to build the physical structure.

Further, the present disclosure also provides the interface for the second users 104, such as, for example, customers, dealers, builders, construction companies, or the like to view and select one or more of these designs. Additionally, method 700 may enable the second user 104 to modify and view the virtual structure using the designs in various views such as, 3D, perspective and the like. Further, the designs may be converted into a format that can be readily uploaded to the 3D construction machine to further build the physical structure.

The present disclosure may facilitate determining royalty for the designs based on the usage of these designs by the second users 104 and other parameters. Accordingly, the payment to be paid to the first users 102 may also be decided.

The present disclosure is described herein with reference to system architecture, block diagrams, flowchart illustrations of methods, and computer program products according to various aspects of the disclosure. It will be understood that each functional block of the block diagrams and the flowchart illustrations, and combinations of functional blocks in the block diagrams and flowchart illustrations, respectively, can be implemented by computer program instructions.

These computer program instructions may be loaded onto a general-purpose computer, special-purpose computer, or other programmable data-processing apparatus to produce a machine, such that the instructions that execute on the computer or other programmable data-processing apparatus create means for implementing the functions specified in the flowchart block or blocks. These computer program instructions may also be stored in a computer-readable memory that can direct a computer or other programmable data-processing apparatus to function in a particular manner, such that the instructions stored in the computer-readable memory produce an article of manufacture including instruction means which implement the function specified in the flowchart block or blocks. The computer program instructions may also be loaded onto a computer or other programmable data-processing apparatus to cause a series of operational steps to be performed on the computer or other programmable apparatus to produce a computer-implemented process such that the instructions which execute on the computer or other programmable apparatus provide steps for implementing the functions specified in the flowchart block or blocks.

Accordingly, functional blocks of the block diagrams and flow diagram illustrations support combinations of means for performing the specified functions, combinations of steps for performing the specified functions, and program instruction means for performing the specified functions. It will also be understood that each functional block of the block diagrams and flowchart illustrations, and combinations of functional blocks in the block diagrams and flowchart illustrations, can be implemented by either special purpose hardware-based computer systems which perform the specified functions or steps, or suitable combinations of special purpose hardware and computer instructions. Further, illustrations of the process flows and the descriptions thereof may make reference to user windows, web pages, websites, web forms, prompts, etc. Practitioners will appreciate that the illustrated steps described herein may comprise in any number of configurations including the use of windows, web pages, hypertexts, hyperlinks, web forms, popup windows, prompts, and the like. It should be further appreciated that the multiple steps as illustrated and described may be combined into single web pages and/or windows but have been expanded for the sake of simplicity. In other cases, steps illustrated and described as single process steps may be separated into multiple web pages and/or windows but have been combined for simplicity.

### TERMINOLOGY

A “first user,” as used herein, may include one or more individuals, a business, an entity, a group, a software and/or a hardware that desires to utilize the disclosure to build one or more designs for a physical structure and/or provide designs for purchase. For example, the first user may be a design engineer that may intend to either design one or more structures and/or provide the designs for purchase to customers.

A “second user,” as used herein, may include any individual, business, entity, group, dealer, software and/or hardware that desires to utilize the disclosure to select one or more designs provided for purchase from the first user. In an example, the second user may be a construction company that may intend to use the designs of the first user in 3D construction.

A “physical structure,” as used herein, may include any structures or parts of the structures such as, a house, a building that may be constructed using any additive manufacturing methods such as 3D printing using machines for example, a 3D excavator.

An “interface,” as used herein, may include any environment that may allow the first user and the second user to upload and download the designs respectively. In an example, the interface may include an application hosted on a web platform. In such a case, the first user and the second user may download the application. The interface may allow the corresponding first user and the second user to provide necessary inputs to accordingly execute one or more functions discussed herein.

The systems, methods and computer program products disclosed in conjunction with various aspects of the present disclosure are embodied in a systems and methods for providing an interface enabling users to select one or more designs to be used in the 3D construction of the physical structure.

While aspects of the present disclosure have been particularly shown and described with reference to the aspects above, it will be understood by those skilled in the art that various additional aspects may be contemplated by the modification of the disclosed machines, systems and methods without departing from the spirit and scope of what is disclosed. Such aspects should be understood to fall within the scope of the present disclosure as determined based upon the claims and any equivalents thereof.

We claim:

1. A method comprising:
receiving a design file in a first format at a computer-based system, wherein the design file is indicative of a structural design;
categorizing the structural design into a first category based on at least a structure type associated with the structural design;
analyzing the structural design, by the computer-based system, based on at least a structural criterion;
assigning a structural value to the structural design based on at least the analyzing of the structural design;
generating an additive manufacturing design based on at least the structural design, wherein the additive manufacturing design is generated in a second format and is configured to be processed by an additive manufacturing machine to construct at least a portion of a structure based on at least the structural design in a layer-by-layer manner; and
causing a display to be rendered, the display comprising a three-dimensional representation of the structural design, the first category, and the first structural value,
wherein the structural type is at least one of a building type or a component type.

2. The method of claim 1, further comprising:
providing, to a first user, a design modification based on at least the analyzing of the structural design; and
enabling the first user to incorporate the design modification into the structural design.

3. The method of claim 1, further comprising:
determining a power level of the structural design based on at least the analyzing of the structural design; and
determining, based on at least the power level and a positioning of the structure, whether the structure can be powered by a local energy source.

4. The method of claim 3, further comprising determining a modification to one of an aspect of the structural design or the positioning of the structure to modify an output of the local energy source.

5. The method of claim 1, wherein the structural criterion includes at least one of a strength criterion, a cost criterion, an aesthetic criterion, or a material grade.

6. The method of claim 1, further comprising updating the structural value based on at least a popularity of the structural design.

7. The method of claim 1, wherein the design file is received via a design tool of the computer-based system.

8. The method of claim 7, further including generating a third format of the structural design based on at least the structural design, wherein the third-format is a standard format associated with the design tool.

9. The method of claim 7, wherein the first format is a standard format associated with the design tool.

10. The method of claim 1, wherein the building type includes at least one of a single-family home type, a multi-family home type, a but type, a silo type, a decorative archway type, a column type, a pavilion type, a pergola type, a gazebo type, a porch type, a water feature type, a water storage type, a fortification, a storage building type, a shed type, a shelter, a multi-story building type, a cellar type, a masonry oven type, an animal housing type, a barrack type, or a garage type.

11. A method comprising:
receiving a first format of a structural design at a computer-based system;
analyzing the structural design based on at least a structural criterion;
assigning a first structural value to the structural design based on at least the analyzing of the structural design; and
generating an additive manufacturing design based on at least the structural design,
wherein the additive manufacturing design is generated in a second format and is configured to be processed by an additive manufacturing machine to construct at least a portion of a structure.

12. The method of claim 11, further comprising:
evaluating the structural design to identify an ancillary component to be included in the structure;
determining a provider of the ancillary component; and
associating ordering information for the ancillary component with the structural design, wherein the ordering information is based on at least the provider.

13. The method of claim 11, further comprising:
evaluating the structural design to identify an ancillary component to be included in the structure;
determining that the ancillary component is not available; and
providing a design modification based on at least an availability of an alternative ancillary component.

14. The method of claim 11, wherein the first format of the structural design is received via a design tool of the computer-based system and the first format is a standard format of the design tool.

15. The method of claim 11, wherein the structural design is associated with one or more designers contributing to the creation of the structural design, and further comprising transmitting a notification to the one or more designers when the additive manufacturing design is generated.

16. The method of claim 11, further comprising:
receiving feedback data related to the structural design; and
providing a modification of the structural design based on at least the feedback data.

17. The method of claim 11, wherein the structural criterion includes at least one of a strength criterion, cost criterion, an aesthetic criterion, or a material grade.

18. The method of claim 11, further including:
determining that the structural criterion does not meet an associated strength criteria requirement; and
receiving a modification of the structural design in the first format.

19. A system, comprising:
a user interface;
a design tool for receiving a structural design in a first format from a first user via the user interface, the structural design having a structure type;
an analytics engine configured to:
determine a first category of the structural design based on at least the structure type;
analyze the structural design based on at least a structural criterion;
assign a structural value to the structural design based on at least the analyzing of the structural design; and
generate an additive manufacturing design based on at least the structural design, wherein the additive manufacturing design is generated in a second format and is configured to be processed by an additive manufacturing machine to construct at least a portion of a structure.

20. The system of claim 19, wherein the analytics engine is further configured to:
determine a power level of the structural design based on at least the analyzing of the structural design; and
determine, based on at least the power level and a positioning of the structure, whether the structure can be powered by a micro-grid.
